(19) United States
(12) Patent Application Publication
(10) Pub. No.: US 2001/0047753 A1
(43) Pub. Date: Dec. 6, 2001

(54) Treatment solution discharge apparatus

(75) Inventors: Shuichi Nagamine, Kumamoto (JP); Shinichi Hayashi, Kumamoto (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Tokyo Electron Limited, Minato-ku (JP)

(21) Appl. No.: 09/861,720

(22) Filed: May 22, 2001

(30) Foreign Application Priority Data
May 24, 2000 (JP) 2000-152519

(51) Int. Cl. B05C 5/00

(52) U.S. Cl. 118/666; 118/319; 118/320

(57) ABSTRACT

The present invention is a treatment solution discharge apparatus having a main body with a solution storage portion being formed therein, for discharging a treatment solution in the solution storage portion onto a substrate from discharge ports provided in the main body, and has a first treatment solution supply pipe and a second treatment solution supply pipe for supplying the treatment solution to the aforementioned solution storage portion from an outside of the main body, a first temperature control pipe in which a fluid for controlling temperature flows and which is disposed over an outer circumference of the first treatment solution supply pipe, and a second temperature control pipe in which the fluid for controlling temperature flows and which is disposed over an outer circumference of the second treatment solution supply pipe, and the first temperature control pipe is connected to one end portion of a solution storage portion temperature control pipe disposed in the solution storage portion, and the other end portion of the solution storage portion temperature control pipe is connected to a first transfer pipe for transferring the fluid for controlling temperature to a predetermined place outside the main body, and the second temperature control pipe is connected to a second transfer pipe located outside the solution storage portion, for transferring the fluid for controlling temperature directly to a predetermined place outside the main body.

### BACKGROUND OF THE INVENTION

1. Field of the Invention

The present invention relates to a treatment solution discharge apparatus.

2. Description of the Related Art

In a photolithography process in semiconductor device fabrication processes, for example, resist coating treatment in which a resist solution is applied to a top surface of a semiconductor wafer (hereinafter, called “a wafer”) and a resist film is formed thereon, exposure processing in which a pattern is exposed on the resist film, developing treatment in which development treatment is performed for the resist film of the wafer after the exposure, and the like are performed in order, and thereby a predetermined circuit pattern is formed on the wafer.

The aforementioned developing treatment is carried out by supplying a developing solution to a top surface of the wafer, and on supplying the developing solution onto the top surface of the wafer, a developing solution discharge apparatus called, for example, a developing solution nozzle is conventionally used.

The conventional developing solution discharge apparatus frequently used has a solution storage portion for the developing solution inside a long thin main body in a rectangular parallelepiped form longer than a diameter of the wafer. A plurality of discharge ports are formed along a longitudinal direction of an undersurface of this main body, and the developing solution in the aforementioned solution storage portion is discharged onto a substrate from the discharge ports. In order to make the discharge from each discharge port more uniform, the supply of the developing solution from an outside to the solution storage portion is performed from the developing solution supply pipes connected to portions near both end portions on the top surface of the main body.

The developing treatment itself is influenced by the temperature of the developing solution to a large extent, and therefore the temperature of the developing solution discharged onto the wafer has to be maintained at a predetermined temperature. Thus, in the conventional developing solution discharge apparatus, such a predetermined temperature is maintained by a temperature controlling pipe connected to the main body independently from the aforementioned developing solution supply pipe and having a heat exchange portion at which heat exchange is performed with the developing solution in the solution storage portion. A fluid for controlling temperature, for example, water set at a predetermined temperature, is fed into the temperature controlling pipe and thereby heat exchange is performed between the water and the developing solution in the solution storage portion, thereby maintaining the developing solution inside the solution storage portion at the predetermined temperature.

However, the above prior art has the following disadvantages. First of all, the developing solution itself is supplied into the solution storage portion of the main body without any temperature control being performed, and therefore a temperature controlling fluid having a considerable temperature difference from the developing solution has to be fed to the temperature controlling pipe in order to control the developing solution at a predetermined temperature within a limited space being the solution storage portion. Accordingly, for example, if the temperature controlling fluid is fed in one direction as it is from one end portion to the other end portion of the heat exchange portion located in the solution storage portion, large heat exchange is performed on its way, whereby the temperature difference becomes large between the starting point of the flow and the endpoint thereof, specifically, between the one end portion and the other end portion. As the result, the developing solution discharged from the discharge ports located at one end portion side of the solution storage portion and the developing solution discharged from the discharge ports located at the other end portion side are discharged onto the wafer with a large temperature difference existing between them. There arises the fear that such a temperature difference inhibits uniformity of the development within the surface of the wafer.

In order to prevent the above situation, an attempt to reduce the temperature difference between one end portion side and the other end portion side to a minimum by arranging the temperature controlling pipe in a U form in the solution storage portion so that the fluid makes a U-turn from the one end portion to the other end portion and from the other end portion to the one end portion instead of the fluid being fed in one direction from the one end portion to the other end portion. However, the above method causes the disadvantage in the following performance of the developing solution to the temperature controlling fluid due to flow-rate pressure loss at the curved portion of the pipe, whereby a large temperature difference occurs between the area near the curved portion and the other portion, and improvement cannot be made eventually to such an extent as the temperature difference in the developing solution according to the positions of the discharge ports can be permitted.

In addition, arranging the temperature controlling pipe in the U form so that the fluid makes a U-turn from the one end portion to the other end portion, and from the other end portion to the one end portion means that the proportion of the temperature controlling pipe in the volumetric capacity inside the solution storage portion becomes large, and as the result, there arises the fear that a predetermined amount of developing solution cannot be stored in the solution storage portion.

### SUMMARY OF THE INVENTION

The present invention is made in view of the above points, and its object is to reduce a temperature control inside a solution storage portion to a minimum and to make the temperature of the treatment solution discharged from each discharge port uniform in an apparatus for discharging various kinds of treatment solutions including a developing solution onto various kinds of substrates including the wafer.

In order to attain the above object, the present invention is a treatment solution discharge apparatus having a main body with a solution storage portion being formed therein, for discharging a treatment solution in the solution storage portion onto a substrate from discharge ports provided in the main body, having a first treatment solution supply pipe and a second treatment solution supply pipe for supplying the treatment solution to the solution storage portion from an outside of the main body, a first temperature control pipe in which a fluid for controlling temperature flows and which is disposed over an outer circumference of the first treatment solution supply pipe, and a second temperature control pipe in which the fluid for controlling temperature flows and which is disposed over an outer circumference of the second treatment solution supply pipe, and the first temperature control pipe is connected to one end portion of a solution storage portion temperature control pipe disposed in the solution storage portion, the other end portion of the solution storage portion temperature control pipe is connected to a first transfer pipe for transferring the fluid for controlling temperature to a predetermined place outside the main body, and the second temperature control pipe is connected to a second transfer pipe placed outside the solution storage portion, for transferring the fluid for controlling temperature as it is to a predetermined place outside the main body.

According to the present invention, the treatment solution is supplied to the solution storage portion inside the main body through two routes, the first treatment solution supply pipe and the second treatment solution supply pipe. The corresponding first temperature control pipe and the second temperature control pipe in which the temperature controlling fluid flows are disposed over the outer circumference of the first developing solution supply pipe and the second treatment solution supply pipe, and thus the treatment solution is controlled in temperature by the first temperature control pipe and the second temperature control pipe until the time just before it flows into the solution storage portion.

After the treatment solution is introduced into the solution storage portion, it is controlled in temperature by the solution storage portion temperature control pipe disposed inside the solution storage portion, and as described above, the treatment solution is controlled in temperature, for example, at a predetermined temperature by the first and the second temperature control pipes until the time just before it flows into the solution storage portion, thus making it possible to control the treatment solution inside the solution storage portion at a predetermined temperature with very small heat exchange unlike the prior art. Consequently, it is not necessary to especially increase the flow of the temperature controlling fluid fed into the solution storage portion temperature control pipe disposed in the solution storage portion, and it is not necessary to feed the fluid with the considerable temperature difference from the treatment solution. In other words, a large amount of heat exchange is not required inside the solution storage portion.

In the present invention, in view of the above point, the first temperature control pipe is connected to one end portion of the solution storage portion temperature control pipe, and thus the temperature controlling fluid flowing inside the first temperature control pipe performs heat exchange with the treatment solution inside the solution storage portion while the fluid is flowing through the solution storage portion temperature control pipe as it is to the other end portion, so that the temperature of the treatment solution inside the solution storage portion is controlled again. Consequently, the treatment solution discharged from the treatment solution discharge ports are also controlled in temperature in the solution storage portion until the time just before it is discharged, thus making it possible to keep the temperature of the treatment solution discharged from the treatment solution discharge ports at a predetermined temperature and to discharge the treatment solution uniformly.

The amount of heat exchange via the storage portion temperature control pipe inside the aforementioned solution storage portion is very small as described above, and thus, even if it is the heat exchange performed when the temperature controlling fluid flows in one direction from one end portion to the other end portion, there is little temperature difference between the one end portion and the other end portion, and the temperature of the treatment solution discharged from each treatment solution discharge port is uniform. Accordingly, the solution storage portion temperature control pipe can sufficiently perform its function even if it has a small pipe diameter, and the temperature controlling fluid can suitably carry out temperature control of the treatment solution inside the solution storage portion even if it flows in one direction, thus making it unnecessary to arrange a U-shaped pipe, and making it sufficient to use a simple linear pipe. Consequently, the curved portion of the pipe can be reduced to a minimum, and the reduction in following performance based on the flow-rate pressure loss as conventionally can be reduced. Further, the proportion of the heat exchange portion inside the solution storage portion can be made smaller than the prior art, and the proportion of the treatment solution which can be stored is increased more than the prior art.

Since the other end portion of the storage portion temperature control pipe is connected to the first transfer pipe, the temperature controlling fluid, which has performed heat exchange with the treatment solution inside the solution storage portion while flowing through the storage portion temperature control pipe, is transferred to a predetermined place through the first transfer pipe. The temperature controlling fluid of this kind is normally circulated and used, and thus, for example, the first transfer pipe may have the structure of a return pipe being a path on the return side of such a circulating system.

Meanwhile, the aforementioned second temperature control pipe in charge of the temperature control of the treatment solution flowing through the first treatment solution supply pipe is connected to the second transfer pipe located outside the aforementioned solution storage portion, for transferring the fluid to a predetermined place outside the aforementioned main body as it is, and thus the temperature controlling fluid flowing through the second temperature control pipe does not enter the solution storage portion, but it is transferred to a predetermined place through the second transfer pipe as it is. The place to which it is transferred by the first and the second transfer pipes may be the same place, or may be different places. Specifically, it may be suitable to connect the transfer pipes, for example, to independent circulating systems respectively.

The “pipe” in the present invention includes something like a tube made of a soft material. Further, the temperature controlling fluid may be a liquid or a gas.

### BRIEF DESCRIPTION OF THE DRAWINGS

FIG. 1 is a plane view showing an outer appearance of a coating and developing system having a developing apparatus in which a developing solution nozzle according to the present embodiment is adopted;

FIG. 2 is a front view of the coating and developing system in FIG. 1;

FIG. 3 is a rear view of the coating and developing system in FIG. 1;

FIG. 4 is an explanatory view in a longitudinal section of the developing apparatus in which the developing solution nozzle according to the present embodiment is adopted;

FIG. 5 is an explanatory view in a transverse cross section of the developing apparatus in FIG. 4;

FIG. 6 is a perspective view of the developing solution nozzle according to the present embodiment;

FIG. 7 is a longitudinal sectional view of the developing solution nozzle in FIG. 6;

FIG. 8 is an explanatory view showing a system the developing solution nozzle in FIG. 6; and

FIG. 9 is a plane view of the developing solution nozzle in FIG. 6.

### DETAILED DESCRIPTION OF THE PREFERRED EMBODIMENTS

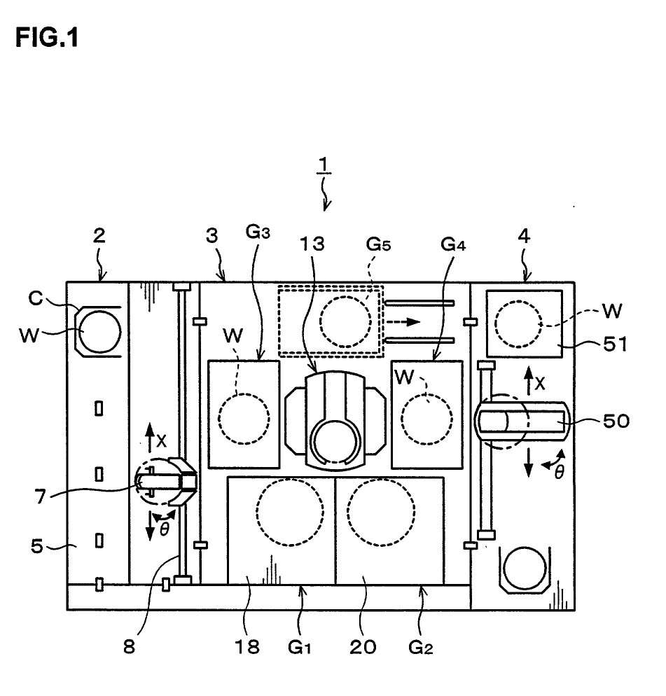

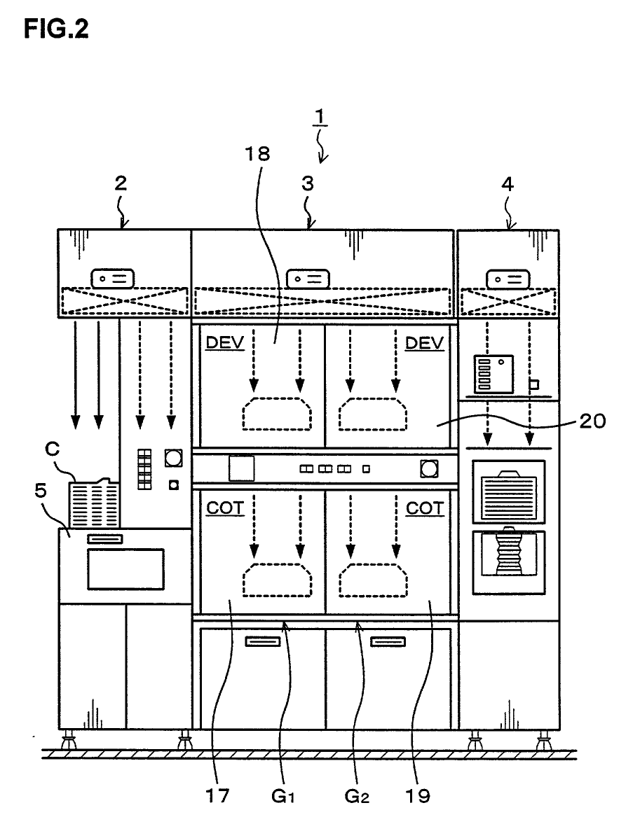

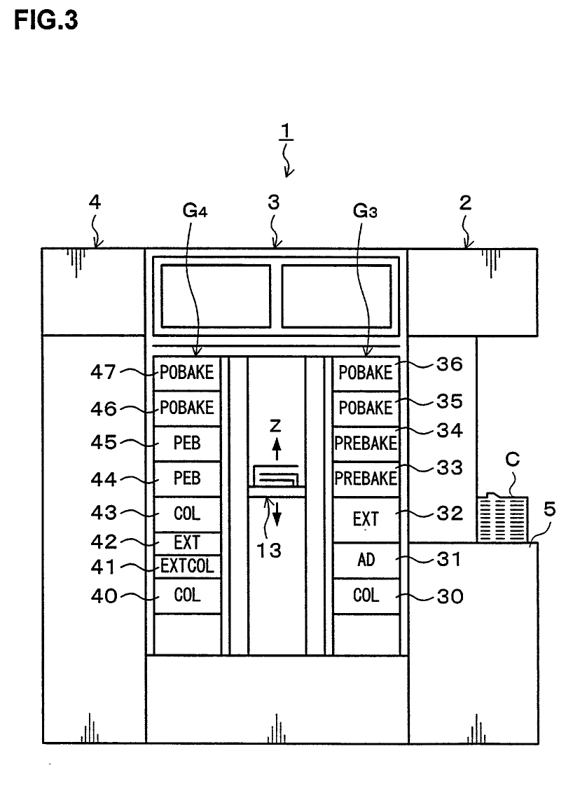

A preferred embodiment of the present invention will be explained below. FIG. 1 is a plane view of a coating and developing system 1 having a developing apparatus in which a developing solution nozzle being an example of a treatment solution discharge apparatus according to the present embodiment, FIG. 2 is a front view of the same, and FIG. 3 is a rear view of the same. As shown in FIG. 1, the coating and developing system 1 has a structure in which a cassette station 2 for carrying, for example, 25 wafers W from/to the outside to/from the coating and developing system 1 in the unit of cassette and for carrying the wafers W into/from a cassette C, a processing station 3 in which various kinds of multi-tiered processing and treatment units for performing predetermined processing and treatment for the wafers one by one in the coating and developing process are disposed, and an interface section 4 for receiving and delivering the wafer W from/to an aligner (not shown) provided adjacently to the processing station 3, are integrally connected.

In the cassette station 2, a plurality of cassettes C are mountable at predetermined positions on a cassette mounting table 5 in a line in an X-direction (the up-and-down direction in FIG. 1). Further, a wafer carrier 7, which is movable to the direction of arrangement of the cassettes (the X-direction) and to the direction of arrangement of the wafers W housed in the cassette C (a Z-direction; a vertical direction), is provided to be movable along a carrier path 8 and is selectively accessible to each of the cassettes C.

The wafer carrier 7 has an alignment function for aligning the wafer W. The wafer carrier 7 is structured so as to be also accessible to an extension unit 32 included in a third processing unit group G3 on the side of the processing station 3 as will be described later.

In the processing station 3, a main transfer device 13 is provided in a center part thereof, and various kinds of processing units are multi-tiered around the periphery of the main transfer device 13 to compose processing unit groups. In the coating and developing system 1, there disposed are four processing unit groups G1, G2, G3 and G4, and the first and the second processing unit groups G1 and G2 are disposed on the front side of the coating and developing system 1, the third processing unit group G3 is disposed adjacently to the cassette station 2, and the fourth processing unit group G4 is disposed adjacently to the interface section 4. Further, as an option, a fifth processing unit group G5 depicted by the broken line can be additionally arranged on the rear side thereof. The aforementioned main transfer device 13 can transfer the wafer W into/from various kinds of processing units described later disposed in these processing unit groups G1, G2, G3, and G4.

In the first processing unit group G1, a resist coating unit 17 for applying a resist solution to the wafer W and a developing apparatus 18 in which the developing solution nozzle according to the present embodiment is adopted are two-tiered in the order from the bottom, for example, as shown in FIG. 2. As for the processing unit group G2, a resist coating unit 19 and a developing apparatus 20 are similarly two-tiered in the order from the bottom.

In the third processing unit group G3, a cooling unit 30 for cooling the wafer W, an adhesion unit 31 for increasing the adhesion between a resist solution and the wafer W, the extension unit 32 for keeping the wafer W waiting, prebaking units 33 and 34 for drying a solvent in the resist solution, postbaking units 35 and 36 for performing heating treatment after developing treatment, and so on are, for example, seven-tiered in the order from the bottom.

In the fourth processing unit group G4, for example, a cooling unit 40, an extension and cooling unit 41 for naturally cooling the wafer W being placed, an extension unit 42, a cooling unit 43, post exposure baking units 44 and 45 for performing heat treatment after exposure processing, postbaking units 46 and 47, and the like are, for example, eight-tiered in the order from the bottom.

A wafer carrier 50 is provided at a center portion of the interface section 4. The wafer carrier 50 is structured so as to be movable in the X-direction (the up-and-down direction in FIG. 1) and the Z-direction (the vertical direction), and to be rotatable in a θ-direction (a rotational direction around an axis Z), so that it can access the extension and cooling unit 41, the extension unit 42, and a peripheral aligner 51 included in the fourth processing unit group G4, and an aligner (not shown) for performing pattern exposure, and can transfer the wafer W to each of them.

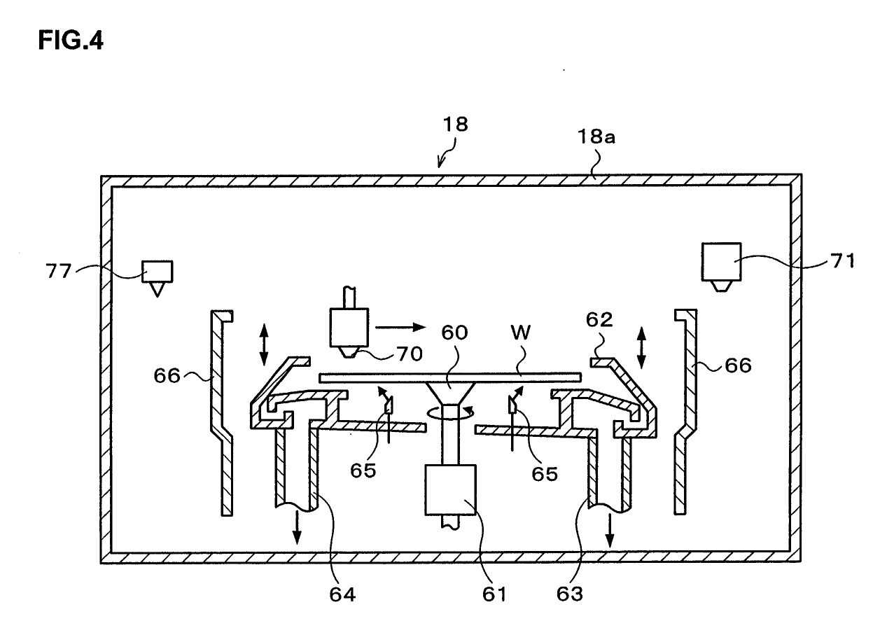

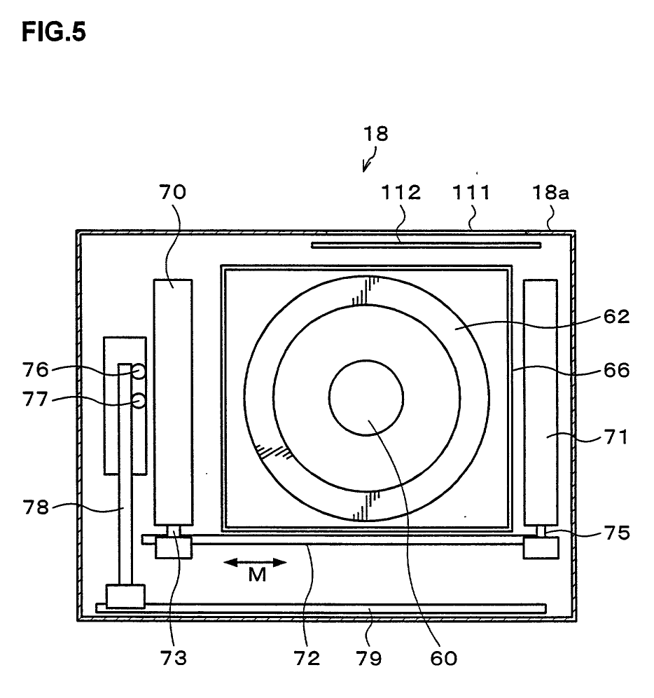

Next, a configuration of the developing apparatus 18 described above will be explained in detail. A spin chuck 60 for holding the wafer W by suction and rotating it is provided in a casing 18a of the developing apparatus 18 as shown in FIGS. 4 and 5. Under the spin chuck 60, provided is a rotary drive mechanism 61 including, for example, a motor for rotating the spin chuck 60 at a predetermined speed. The rotary drive mechanism 61 is provided with a function of moving the spin chuck 60 up and down. It moves the spin chuck 60 up and down when the wafer W is carried in and out, so that the wafer W can be transferred to and from the main transfer device 13.

A ring-shaped inner cup 62 with its top face being opened is provided to enclose the spin chuck 60, outside the outer circumference of the spin chuck 60, so that it receives the developing solution and the like splashed from the wafer W rotated by the aforementioned spin chuck 60 to prevent the surrounding devices from being contaminated. At a bottom portion of the inner cup 62, provided are a drain pipe 63 for discharging the developing solution and the like splashed from the aforementioned wafer W and the like, and an exhaust pipe 64. The inner cup 62 is provided with undersurface cleaning nozzles 65 for discharging a cleaning solution to an undersurface of the wafer W held on the spin chuck 60 and cleaning the undersurface of the wafer W.

A square outer cup 66 with its top face being opened is provided to enclose the inner cup 62, outside the inner cup 62, so as to receive the developing solution and the like, which are not sufficiently received by the aforementioned inner cup 62. The outer cup 66 itself is movable up and down by a drive mechanism (not shown), and, for example, when the developing solution and the like on the wafer W is shaken off by rotating the wafer W, the outer cup 66 is located at the position further raised from the state shown in FIG. 4.

Inside the casing 18a, a first developing solution nozzle 70 and a second developing solution nozzle 71 as the treatment solution discharge apparatus are disposed at both sides, that is, an inner side and an outer side to oppose each other with the outer cup 66 between them to discharge and supply a developing solution as a treatment solution onto the wafer W. The first developing solution nozzle 70 is supported by a support arm 73 movable along a guide rail 72 (in the direction of the double-headed arrow M in FIG. 5), and the support arm 73 is moved up and down by a suitable hoisting and lowering mechanism (not shown). Thus, the first developing solution nozzle 70 supported thereby can be raised and lowered vertically. The second developing solution nozzle 71 is also supported by a support arm 75 movable along the aforementioned guide rail 72, and the support arm 75 is moved up and down by a suitable hoisting and lowering mechanism (not shown). According to the above structure, the first developing solution nozzle 70 and the second developing solution nozzle 71 can scan-move over the wafer W held by the spin chuck 60 along the aforementioned M direction across the outer cup 66.

At an outer side of the first developing solution nozzle 70 in the casing 18a, a cleaning solution nozzles 76 and 77 for discharging a cleaning solution onto the wafer W to clean the wafer W is disposed by being supported by a support arm 78. The support arm 78 is moved up and down by a suitable hoisting and lowering mechanism (not shown), and is moved along a guide rail 79 disposed to be parallel with the aforementioned guide rail 72. According to the above structure, the cleaning solution nozzles 76 and 77 can discharge a cleaning solution to a predetermined position on the wafer W held by the spin chuck 60 across the outer cup 66 and the first developing solution nozzle 70.

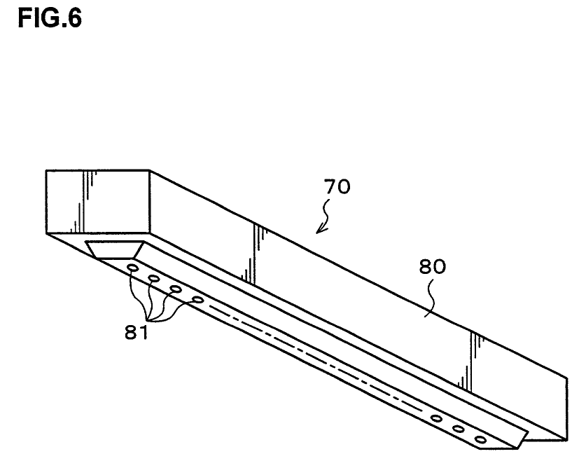

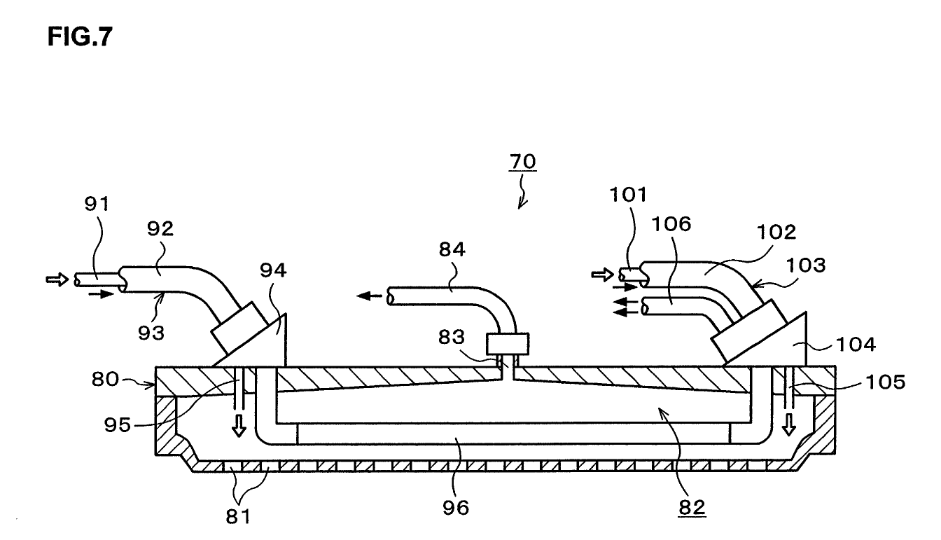

The first developing solution nozzle 70 and the second developing solution nozzle 71 have the same structure. Explaining the details of, for example, the first developing solution nozzle 70 with reference to FIG. 6 and FIG. 7, it has a long thin main body 80 almost in a rectangular parallelepiped shape as a whole, and the length in a longitudinal direction of the main body 80 is at least longer than a diameter of the wafer W. A plurality of developing solution discharge ports 81 are provided in an undersurface of the first developing solution nozzle 70 to be aligned along the longitudinal direction.

A solution storage portion 82 longer in the longitudinal direction communicated with each of the aforementioned developing solution discharge ports 81 is formed inside the main body 80 as shown in FIG. 7. It is structured so that the developing solution fed into the main body 80 is stored therein once, and thereafter, the developing solution can be discharged from each of the developing solution discharge ports 81 at the same flow rate at the same time. A top surface inside the solution storage portion 82 has the shape inclined to be gradually higher toward a center portion, and an exhaust port 83 is formed at its crest portion. An exhaust pipe 84 is connected to the exhaust port 83. According to the above structure, air bubbles and the like inside the solution storage portion 82 are discharged outside from the exhaust port 83 through the exhaust pipe 84, thus preventing air bubbles from entering the developing solution discharged from each developing solution discharge port 81.

A first introduction pipe 93 with a so-called double pipe structure, in which a first developing solution supply pipe 91 as a first treatment solution supply pipe for supplying the developing solution from a developing solution supply source (not shown) into the solution storage portion 82 is integral with a first temperature control pipe 92 disposed over the outer circumference of the first developing solution supply pipe 91, for a temperature controlling fluid to flow therein, is connected obliquely to a top surface of the main body 80 via a connecting member 94. The first developing solution supply pipe 91 and the first temperature control pipe 92 are branched from each other inside the connecting member 94, and the developing solution supplied from the first developing solution supply pipe 91 is supplied into the solution storage portion 82 via a supply port 95.

Thus, the developing solution from the first developing solution supply pipe 91 is controlled in temperature at a predetermined temperature by a temperature controlling fluid flowing inside the first temperature control pipe 92 until the time immediately before it flows into the solution storage portion 82. Meanwhile, the temperature control pipe 92 is connected to one end portion of a solution storage portion temperature control pipe 96 disposed along a longitudinal direction inside the solution storage portion 82.

A second introduction pipe 103 with a double pipe structure, in which a second developing solution supply pipe 101 as a second treatment solution supply pipe for supplying the developing solution from a developing solution supply source (not shown) into the solution storage portion 82 is integral with a second temperature control pipe 102 disposed over the outer circumference of the second developing solution supply pipe 101, for a temperature controlling fluid to flow therein, is connected obliquely to a top surface of the main body 80 via a connecting member 104. The second developing solution supply pipe 101 and the second temperature control pipe 102 are branched from each other inside the connecting member 104, and the developing solution supplied from the second developing solution supply pipe 101 is supplied into the solution storage portion 82 via a supply port 105. Thus, the developing solution from the second developing solution supply pipe 101 is controlled in temperature at a predetermined temperature by a temperature controlling fluid flowing inside the second temperature control pipe 102 until the time immediately before it flows into the solution storage portion 82.

Meanwhile, the second temperature control pipe 102 does not enter the solution storage portion 82, but it is connected to the aforementioned connecting member 104 to be connected to a return pipe 106 being a transfer pipe with a structure in which a first transfer pipe is integral with a second transfer pipe connected to a temperature control fluid circulating system (not illustrated) for supplying the temperature control fluid. The return pipe 106 is connected to the other end portion of the aforementioned solution storage portion temperature control pipe 96. The return pipe 106 itself is connected obliquely to the top surface of the main body 80 via the connecting member 104.

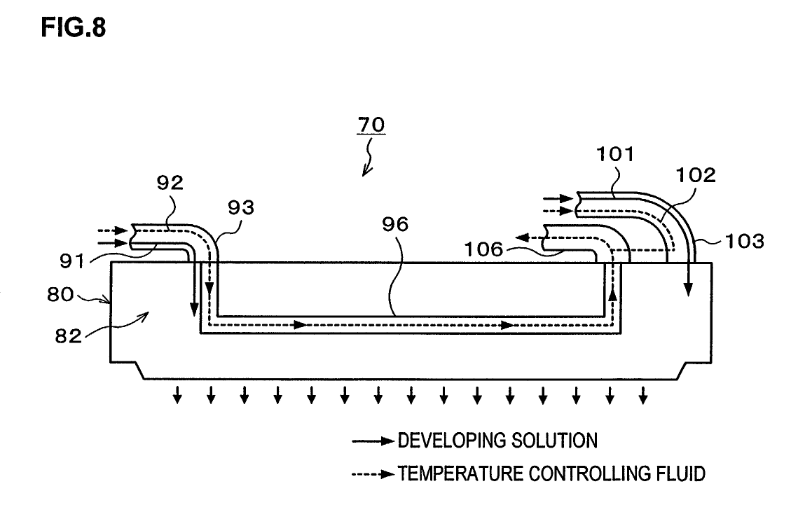

Schematically showing the flowing state of the developing solution and the temperature control fluid in the first developing solution nozzle 70 according to the above structure, it is as shown in FIG. 8. Specifically, the developing solution supplied through the first developing solution supply pipe 91 and the second developing solution supply pipe 101 is supplied into the solution storage portion 82 of the main body 80 while it is controlled at a predetermined temperature by the first temperature control pipe 92 and the second temperature control pipe 102. Meanwhile, the temperature controlling fluid flowing through the first temperature control pipe 92 flows through the solution storage portion temperature control pipe 96 disposed inside the solution storage portion 82 of the main body 80 to control the temperature of the developing solution stored in the solution storage portion 82, and thereafter it is returned to the circulating system through the return pipe 106 from the other end portion of the solution storage portion temperature control pipe 96. On the other hand, the temperature controlling fluid flowing through the second temperature control pipe 102 does not enter the solution storage portion 82, but it branches inside the connecting member 104 as it is, then in the aforementioned return pipe 106, it joins the temperature controlling fluid via the first temperature control pipe 92, which flowing through the aforementioned solution storage portion temperature control pipe 96, and it is returned to the aforementioned circulating system.

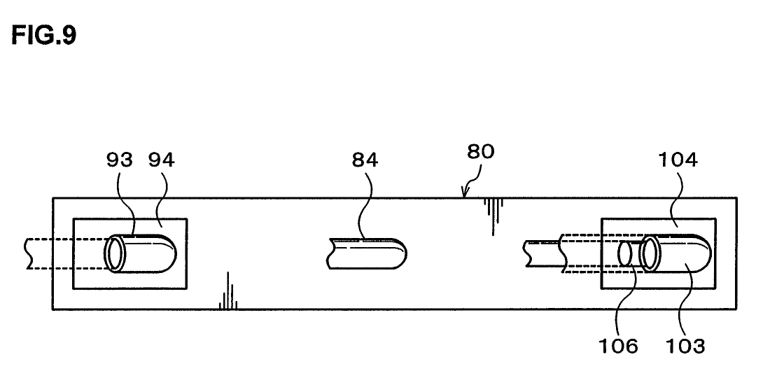

Piping of the first developing solution nozzle 70 on the top surface of the main body 80 is as shown in FIG. 9. Specifically, the first introduction pipe 93 with the double pipe structure in which the first developing solution supply pipe 91 is integral with the first temperature control pipe 92 is arranged toward one side (the aforementioned guide rail 72 side) along the longitudinal direction of the main body 80, and the second introduction pipe 103 with the double structure in which the second developing solution supply pipe 101 is integral with the second temperature control pipe 102 is arranged toward the one side (the aforementioned guide rail 72 side) along the longitudinal direction of the main body 80. Further, the return pipe 106 is similarly arranged to the aforementioned one side along the longitudinal direction of the main body 80.

A transfer port 111 for carrying in and out the wafer W by the transfer device 13 and a shutter 112 for opening and closing the transfer port 111 are provided at the side surface of the casing 18a, so that the shutter 112 is closed except when the wafer W is carried in and out to thereby prevent the treatment solution from splashing from the casing 18a and maintain a predetermined atmosphere.

Next, developing treatment carried out in the developing apparatus 18 structured as above will be explained together with process steps in the photolithography process performed in the coating and developing treatment system 1. The wafer carrier 7 initially takes one of the unprocessed wafers W out of the cassette C, and carries it into the adhesion unit 31 included in the third processing unit group G3. The wafer W, which is coated with an adhesion promoter such as an HMDS for increasing the adherence with the resist solution in the adhesion unit 31, is transferred to the cooling unit 30 by the main transfer device 13, and cooled to a predetermined temperature. Thereafter, the wafer W is transferred to the resist coating unit 17 or 19, the prebaking unit 34 or 35 in order, whereby a predetermined resist coating treatment is applied to the wafer W. Thereafter, the wafer W is transferred to the extension and cooling unit 41 and cooled to a predetermined temperature.

The cooled wafer W is taken out by a wafer carrier 50, and then transferred to an aligner (not shown) via a peripheral aligner 51. The wafer W for which pattern exposure processing is finished by the aligner is transferred to the extension unit 42 by the wafer carrier 50, then it is held by the main transfer device 13, and is immediately transferred to the post exposure baking unit 44 or 45, and the cooling unit 43 in order. After a predetermined temperature treatment is performed in these processing units, the wafer W is transferred to the developing apparatus 18 or 20.

When the wafer W is thus carried into the developing apparatus 18 by the main transfer device 13, it is held on the spin chuck 60 by suction, and the wafer W is lowered. For example, the first developing solution nozzle 70 discharges the developing solution onto the wafer W from the developing solution discharge ports 81 in its undersurface while scan-moving over the wafer W from the outside of one end portion of the wafer W placed at a predetermined position inside the inner cup 62, and the developing solution is heaped on the wafer W. When the first developing solution nozzle 70 finishes the discharge, it returns to an original position. The wafer W is kept at rest as it is for a predetermined period of time and subjected to developing treatment.

After the predetermined period of time elapses, the cleaning nozzles 76 and 77 are moved above the center portion of the wafer W, while the wafer W is being rotated by the spin chuck 60, and while a predetermined cleaning solution, for example, pure water, is being discharged to the wafer W, a cleaning solution, for example, pure water is also discharged to the undersurface of the wafer W from the undersurface cleaning nozzle 66 simultaneously, thus performing cleaning treatment for the wafer W. The wafer W in this situation is located inside the inner cup 62, and the outer cup 66 is raised, thus receiving the cleaning solution and the like scattered from the wafer W.

Thereafter, when the supply of the cleaning solution is stopped, the wafer W is rotated at a higher speed, whereby the wafer W is dried. When the drying step for the wafer W is finished, all developing treatment for the wafer W is finished, and the wafer W is carried out of the developing apparatus 18 by the main transfer device 13.

In the first developing solution nozzle 70 and the second developing solution nozzle 71 adopted in the developing apparatus 18 performing the above developing treatment, the developing solution supplied from the separate supply source to the solution storage portion 82 of the main body 80 through the first developing solution supply pipe 91 and the second developing solution supply pipe 101 is controlled in temperature by the corresponding first and second temperature control pipes 92 and 102 until the time just before the developing solution flows into the solution storage portion 82, and the temperature control for the developing solution inside the solution storage portion 82 is sufficiently performed with a small amount of heat exchange, thus making it possible to maintain the developing solution inside the solution storage portion 82 at a predetermined temperature by heat exchange only with the solution storage portion temperature control pipe 96 by the temperature controlling fluid directly flowing from the first temperature control pipe 92.

Since it is possible to maintain the developing solution inside the solution storage portion 82 at a predetermined temperature with such a small amount of heat exchange, a curved design and a U-shaped piping for obtaining a larger surface area of the heat exchange portion inside the solution storage portion as in the prior art are not required, and the solution storage portion temperature control pipe 96 in a simple linear form as shown in FIG. 7 is sufficient. From the relationship of the connection, the solution storage portion temperature control pipe 96 in a linear form with only both end portions being curved upward with the diameter of itself being small in size is sufficient, and therefore storage amount of the developing solution inside the solution storage portion 82 can be increased more than the prior art when the volumetric capacity inside the solution storage portion 82 is the same. Since the temperature control inside the solution storage portion 82 is performed by utilizing the temperature controlling fluid flowing from the first temperature control pipe 92, piping for introducing a temperature controlling fluid for additionally controlling the temperature of the developing solution inside the solution storage portion 82 is not required.

Meanwhile, the temperature controlling fluid flowing through the second temperature control pipe 102 is directly fed into the return pipe 106 without entering the solution storage portion 82, then it joins the temperature controlling fluid from the solution storage portion temperature control pipe 96 which has finished heat exchange inside the solution storage portion 82, and it can be returned to a suitable circulating system by the return pipe 106 also used as the first and the second transfer pipes, thus making only one line of the aforementioned return pipe 106 suffice as the piping for returning the fluid to the circulating system, which simplifying the piping.

Further, seeing the outer shape of the entire first developing solution nozzle 70 and second developing solution nozzle 71, the first introduction pipe 93 with the first developing solution supply pipe 91 being integral with the first temperature control pipe 92, the second introduction pipe 103 with the second developing solution supply pipe 101 being integral with the second temperature control pipe 102, and the return pipe 106 are partially obliquely connected to the top surface of the main body 80, thus making it possible to reduce the entire height including each pipe of the first developing solution nozzle 70 and the second developing solution nozzle 71. This point is also important in the relation to the cleaning solution nozzles 76 and 77.

Specifically, in the aforementioned developing apparatus 18, the cleaning solution nozzles 76 and 77 are disposed outside the first developing solution nozzle 70, so that two developing solution nozzles 70 and 71 can be disposed to oppose each other with the outer cup 66 between them (that is, with the wafer W between them), and in doing so, the cleaning solution nozzle 76 and 77 have to pass above the first developing solution nozzle 70 when they move to above the wafer W. In this respect, as described above, in the first developing solution nozzle 70, the first introduction pipe 93, the second introduction pipe 103 and the return pipe 106 are obliquely connected to the top surface of the main body 80 as described above, and the entire height including each pipe of the first developing solution nozzle 70 is reduced to be low, thus making it possible to reduce the height which the cleaning nozzles 76 and 77 have to pass over, and ultimately reduce the entire height of the developing apparatus 18. By extension, when a plurality of multi-tiered developing apparatuses are provided, the height of the entire system can be reduced.

Furthermore, since the first introduction pipe 93, the second introduction pipe 103 and the return pipe 106 are all arranged toward the guide rail 72 side in the casing 18a along the longitudinal direction of the main body 80, the pipes are not protruded in the moving direction of the nozzles, thus making it possible to keep the first developing solution nozzle 70, the second developing solution nozzle 71, and the cleaning solution nozzles 76 and 77 waiting at the waiting positions closely to each other, and in this respect, the entire developing apparatus 18 can be made compact. Further, each of the aforementioned pipes is extended toward the guide rail 72 side, which provides excellent operability at the occasion of maintenance.

The embodiment explained above is related to the developing apparatus for the wafer W in the photolithography process in the semiconductor wafer device fabrication processes, and the present invention is applicable to a developing solution discharge nozzle in a developing apparatus for substrates other than the semiconductor wafers, for example, an LCD substrate. The treatment solution is not limited to the developing solution, and various kinds of treatment solutions such as a resist solution, for example, can be used.

According to the present invention, heat exchange amount inside the solution storage portion is reduced and the temperature of the treatment solution discharged from each discharge port can be made uniform. In addition, the height and the size of the entire apparatus can be made small. The storage amount of the treatment solution inside the solution storage portion can be set larger than the conventional apparatus of the same size.

What is claimed is:

1. A treatment solution discharge apparatus having a main body with a a solution storage portion being formed therein, for discharging a treatment solution in said solution storage portion onto a substrate from discharge ports provided in said main body, comprising:
a first treatment solution supply pipe and a second treatment solution supply pipe for supplying the treatment solution to said solution storage portion from an outside of said main body;
a first temperature control pipe in which a fluid for controlling temperature flows and which is disposed over an outer circumference of said first treatment solution supply pipe; and
a second temperature control pipe in which the fluid for controlling temperature flows and which is disposed over an outer circumference of said second treatment solution supply pipe,
wherein said first temperature control pipe is connected to one end portion of a solution storage portion temperature control pipe disposed in said solution storage portion, and the other end portion of said solution storage portion temperature control pipe is connected to a first transfer pipe for transferring the fluid for controlling temperature to a predetermined place outside said main body, and
wherein said second temperature control pipe is connected to a second transfer pipe placed outside said solution storage portion, for transferring the fluid for controlling temperature directly to a predetermined place outside said main body.

2. A treatment solution discharge apparatus according to claim 1,
wherein the first transfer pipe and the second transfer pipe are the same transfer pipe.

3. A treatment solution discharge apparatus according to claim 1,
wherein said first treatment solution supply pipe and said second treatment solution supply pipe are connected obliquely to a top surface of the main body.

4. A treatment solution discharge apparatus according to claim 1,
wherein the treatment solution is a developing solution.

5. A treatment solution discharge apparatus according to claim 2,
wherein said first treatment solution supply pipe and said second treatment solution supply pipe are connected obliquely to a top surface of the main body.

6. A treatment solution discharge apparatus according to claim 3,
wherein said first treatment solution supply pipe and said second treatment solution supply pipe are connected in the same direction to the top surface of the main body.

7. A treatment solution discharge apparatus according to claim 6,
wherein said first treatment solution supply pipe and said second treatment solution supply pipe are connected along a longitudinal direction of the main body.

8. A treatment solution discharge apparatus according to claim 3,
wherein the first transfer pipe and the second transfer pipe are connected obliquely to the top surface of the main body.

9. A treatment solution discharge apparatus according to claim 6,
wherein the first transfer pipe and the second transfer pipe are connected obliquely to the top surface of the main body.

10. A treatment solution discharge apparatus according to claim 7,
wherein the first transfer pipe and the second transfer pipe are connected obliquely to the top surface of the main body.

11. A treatment solution discharge apparatus according to claim 8,
wherein the first transfer pipe and the second transfer pipe are connected in the same direction to the top surface of the main body.

12. A treatment solution discharge apparatus according to claim 11,
wherein the first transfer pipe and the second transfer pipe are connected along a longitudinal direction of the main body.
